(19) United States
(12) Patent Application Publication
(10) Pub. No.: US 2026/0106048 A1
(43) Pub. Date: Apr. 16, 2026

(54) ISOTOPE PRODUCTION DEVICES, ASSOCIATED COMPONENTS, AND SYSTEMS

(71) Applicants: Paul Marotta, Jersey City, NJ (US); Battelle Energy Alliance, LLC, Idaho Falls, ID (US); University of Idaho, Moscow, ID (US)

(72) Inventors: Piyush Sabharwall, Idaho Falls, ID (US); Richard Christensen, Idaho Falls, ID (US); Paul Marotta, Jersey City, NJ (US); Alberto Cardenas-Melgar, Rexburg, ID (US); Robin Roper, Idaho Falls, ID (US); Kevin Terrill, Idaho Falls, ID (US); Joshua Young, Shelley, ID (US); Teyen Widdicombe, Ucon, ID (US); Joseph Hafen, Rigby, ID (US); Olin Calvin, Ammon, ID (US)

(21) Appl. No.: 19/420,547

(22) Filed: Dec. 15, 2025

Related U.S. Application Data
(62) Division of application No. 17/814,196, filed on Jul. 21, 2022.
(60) Provisional application No. 63/203,423, filed on Jul. 22, 2021.

(51) Int. Cl. G21G 1/02; G21C 3/48; G21C 11/02; G21C 15/04

(52) U.S. Cl. CPC G21G 1/02; G21C 3/48; G21C 11/022; G21C 15/04

(57) ABSTRACT

An isotope production device may include a reactor core configured to contain an aqueous fuel solution. The device may further include shielding material substantially surrounding the reactor core. The device may also include a heat exchanger positioned above the reactor core. The device may further include a flow path extending between the heat exchanger and a bottom of the reactor core. The device may also include an extraction device positioned along the flow path at a position after the heat exchanger, the extraction device configured to extract a portion of the aqueous fuel solution after the heat exchanger. The device may further include an orifice plate coupled to the bottom of the reactor core.

### CROSS-REFERENCE TO RELATED APPLICATIONS

This application is a divisional of U.S. patent application Ser. No. 17/814,196, filed Jul. 21, 2022, which claims the benefit under 35 U.S.C. § 119(e) of U.S. Provisional Patent Application Ser. No. 63/203,423, filed Jul. 22, 2021, the disclosure of each of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Embodiments of the disclosure generally relate to isotope production devices. In particular, embodiments of the disclosure relate to medical isotope production devices and associated components and systems.

### BACKGROUND

Nuclear reactors contain and control nuclear chain reactions that produce heat through a physical process called fission, where a particle (e.g., a neutron) is fired at an atom, which then splits into two smaller atoms and some additional neutrons. Some of the released neutrons then collide with other atoms, causing them to also fission and release more neutrons. A nuclear reactor achieves criticality (commonly referred to in the art as going critical) when each fission event releases a sufficient number of neutrons to sustain an ongoing series of reactions.

The split atoms with released neutrons may create different isotopes. Isotopes are two or more types of atoms that have the same atomic number and different numbers of neutrons in their respective nuclei. Radioactive waste from nuclear reactors generally contains multiple different types of isotopes.

Some isotopes decay rapidly into inert materials (i.e., non-radioactive material). The rapidly decaying isotopes may be useful for treatments or procedures in medical applications, such as in imaging procedures, radiation therapy, etc. The rapidly decaying isotopes may decay into stable inert materials in such a short period of time that the risk of damage to the human body from the radiation is minimized, while the benefits of the radiation may still be utilized by the treatment or procedure. However, the rapidly decaying isotopes must also be used quickly after they are produced, such that the isotopes do not become stable inert materials before the radiation is used.

### BRIEF SUMMARY

Embodiments of the disclosure include an isotope production device. The isotope production device includes a reactor core configured to contain an aqueous fuel solution. The isotope production device further includes a shielding material substantially surrounding the reactor core. The isotope production device also includes a heat exchanger positioned above the reactor core. The isotope production device further includes a flow path defined between an outer surface of the shielding material and an outer casing, the flow path extending between the heat exchanger and a bottom of the reactor core. The isotope production device also includes an extraction device positioned along the flow path at a position before the heat exchanger, the extraction device configured to remove a portion of the aqueous fuel solution after the reactor core and before the heat exchanger.

Another embodiment of the disclosure includes an isotope production device. The isotope production device includes a reactor core configured to induce flow of an aqueous fuel solution through natural convection. The isotope production device further includes an orifice plate coupled to an inlet of the reactor core. The orifice plate is configured to maintain a substantially uniform flow of the aqueous fuel solution through the reactor core. The orifice plate includes a plurality of uniform apertures through the orifice plate. The orifice plate further includes one or more ridges extending from a surface of the orifice plate in a direction toward the reactor core.

Another embodiment of the disclosure includes a method of producing isotopes. The method includes heating an aqueous solution in a reactor core through a nuclear reaction. The method further includes flowing the aqueous solution through the reactor core. The method also includes cooling the aqueous solution in a heat exchanger. The method further includes flowing the aqueous solution downward in a return passage after cooling the aqueous solution. The method also includes diverting a portion of the aqueous solution after flowing the aqueous solution through the reactor core and before cooling the aqueous solution. The method further includes extracting isotopes from the portion of the aqueous solution. The method also includes reintroducing the portion of the aqueous solution into the aqueous solution before cooling the aqueous solution.

### BRIEF DESCRIPTION OF THE DRAWINGS

While the specification concludes with claims particularly pointing out and distinctly claiming embodiments of the disclosure, the advantages of embodiments of the disclosure may be more readily ascertained from the following description of embodiments of the disclosure when read in conjunction with the accompanying drawings in which:

FIG. 1 illustrates a perspective view of an isotope production device in accordance with one or more embodiments of the disclosure;

FIG. 2 illustrates a cross-sectional view of the isotope production device of FIG. 1;

FIGS. 3 through 8 illustrate different views of the isotope production device of FIGS. 1 and 2 with different covers and components removed to view internal components thereof;

FIG. 9 illustrates a perspective view of a distribution ring of an external cooling system of the isotope production device illustrated in FIGS. 1 through 8 in accordance with one or more embodiments of the disclosure;

FIG. 10A illustrates a top view of an orifice plate in accordance with one or more embodiments of the disclosure;

FIG. 10B illustrates a cross-sectional view of the orifice plate of FIG. 10A;

FIG. 11 illustrates a flow model diagram of fluid flowing through the orifice plate of FIGS. 10A and 10B; and

FIG. 12 illustrates a schematic view of an extraction device in accordance with one or more embodiments of the disclosure.

### DETAILED DESCRIPTION

The illustrations presented herein are not meant to be actual views of any particular isotope production device or component thereof, but are merely idealized representations employed to describe illustrative embodiments. The drawings are not necessarily to scale.

As used herein, the term “substantially” in reference to a given parameter means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or even at least about 100% met.

As used herein, relational terms, such as “first,” “second,” “top,” “bottom,” etc., are generally used for clarity and convenience in understanding the disclosure and accompanying drawings and do not connote or depend on any specific preference, orientation, or order, except where the context clearly indicates otherwise.

As used herein, the term “and/or” means and includes any and all combinations of one or more of the associated listed items.

As used herein, the terms “vertical” and “lateral” refer to the orientations as depicted in the figures.

Isotopes used in medical treatments or procedures may be produced using nuclear reactors. The isotopes that may be used in medical treatments are generally the isotopes having relatively short half-lives, such as half-lives of less than about 48 hours, less than about 24 hours, or even less than about 8 hours. To be effective when used in medical treatments, the isotopes are used within a short period of time after they are produced. The isotopes may include, but are not limited to, Se75, Sr89, Y90, Mo99, Tc99, Pd103, I125, I131, Xe133, Cs131, Cs137, Sm153, Dy165, Ho166, Er169, Yb169, Pb212, Bi213, Ra223, Pu238, etc. The isotopes may be harvested from an aqueous fuel solution at different intervals based at least in part on a half-life of the respective isotope and determined need. The intervals may include daily intervals, weekly intervals, monthly intervals (e.g., 30 day intervals), and yearly intervals.

Nuclear reactor devices designed for energy production generate substantial amounts of radiation and heat. Therefore, it may not be safe to use nuclear energy production devices in close proximity to a medical facility. Furthermore, nuclear energy production devices may be formed of advanced materials, which may increase the cost of building the reactors. A nuclear reactor (e.g., an isotope production device, a medical isotope production device) according to embodiments of the disclosure that operates at lower temperatures and pressures may be built using conventional materials and may be safe to operate in close proximity to a medical facility. Operating the nuclear reactor in close proximity to the medical facility may enable the isotopes produced therein to be used more effectively by reducing the amount of the isotopes that decay to an inert state before being used. During use and operation of the nuclear reactor, medical isotopes are produced form the aqueous fuel solution and are subsequently removed from the aqueous fuel solution. Thermal energy (e.g., heat) generated by the nuclear reactor may be used to generate electricity or provide heat to other systems. The aqueous fuel solution is circulated through the nuclear reactor by convection and, therefore, the nuclear reactor does not include pumps or valves.

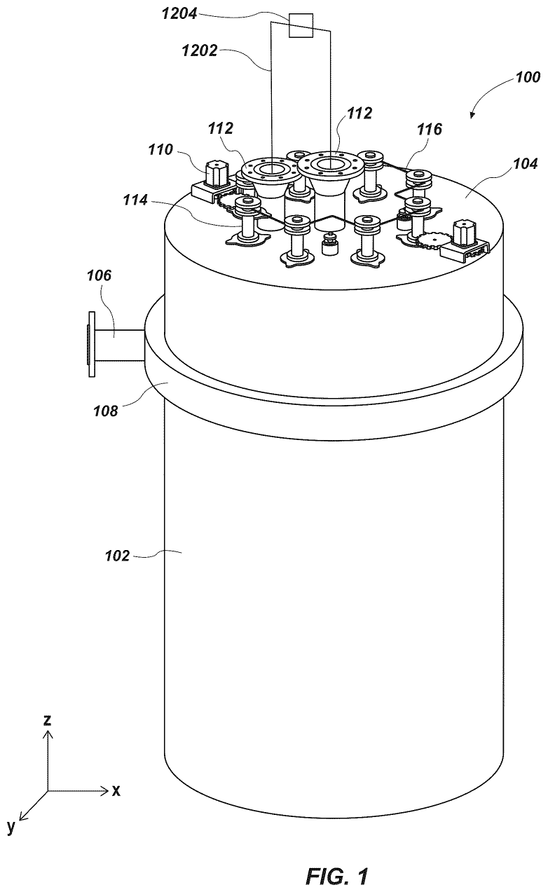

FIG. 1 illustrates an embodiment of an isotope production device 100 configured to generate medical isotopes as a product of a fission reaction. The isotope production device 100 may be substantially enclosed within a casing 102. The casing 102 may be formed from a material configured to substantially prevent radiation and/or free neutrons from leaving the isotope production device 100. For example, the casing 102 may be formed from a reflective material, such as steel (e.g., stainless steel, SS 316, INCOLOY 800®, etc.), beryllium, beryllium metals, beryllium oxide, graphite, tungsten, carbide, gold, etc.

The isotope production device 100 may include a cap 104 on an axial end of the isotope production device 100. The cap 104 may be coupled to an interior wall of the casing 102. For example, the cap 104 may be configured to be inserted into an end of the casing 102, such that the casing 102 substantially surrounds an outer edge of the cap 104. The outer edge of the cap 104 may then be coupled to the inner surface of the casing 102. For example, the outer edge of the cap 104 may be welded or brazed to the inner surface of the casing 102. The cap 104 may have a greater thickness than the casing 102. For example, the casing 102 may have a thickness in the range from about 0.5 cm to about 3 cm, such as from about 0.5 cm to about 2 cm, or about 1 cm. The cap 104 may have a thickness in a range from about 1 cm to about 5 cm, such as from about 2 cm to about 4 cm, or about 3 cm. The cap 104 may include one or more control drives 110. The control drives 110 may be configured to drive one or more drive shafts 114. The drive shafts 114 may be coupled to control drums that control the reactions within the isotope production device 100. The drive shafts 114 may be operatively coupled together through a belt 116 (or chain), such that the control drives 110 may be operatively coupled to multiple drive shafts 114 through the belt 116.

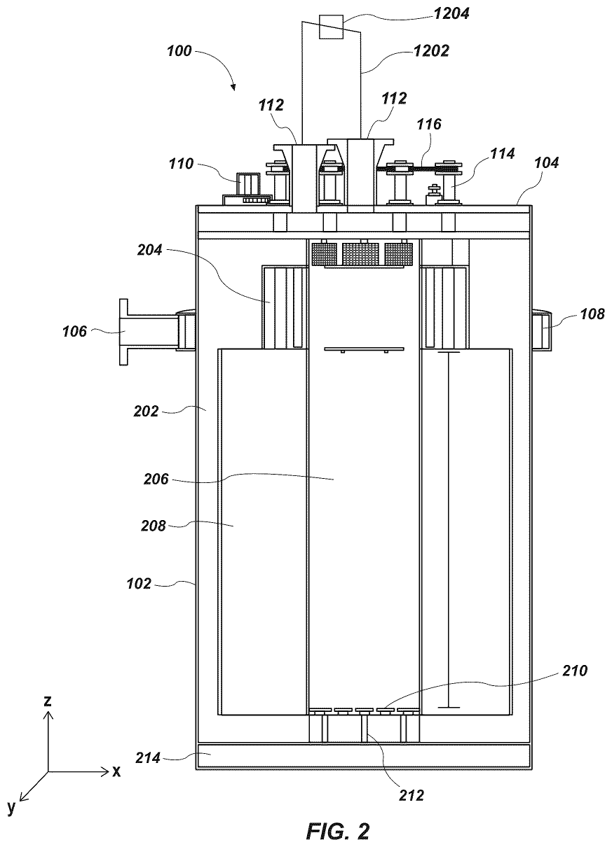

The isotope production device may include an external cooling system, which may be configured to supply a cooling fluid (e.g., cooling liquid or cooling gas) through an inlet 106. The cooling fluid may be distributed around a portion of the isotope production device 100 including a heat exchanger 204, described in further detail below with respect to FIG. 2. The cooling fluid may be distributed by a distribution ring 108 coupled to the inlet 106. After the fluid passes through the heat exchanger 204, the cooling fluid may flow out of the isotope production device 100 through an aperture 112 in the cap 104. The cooling fluid may pass through a heat rejection system, such as a fin tube heat exchanger, water to water heat exchanger, cooling tower, etc., where heat absorbed from the heat exchanger 204 of the isotope production device 100 may be transferred to another medium, such as the atmosphere, a heatsink, a heating system, etc.

The cap 104 may also include additional apertures 113, similar to the outlet aperture 112. The apertures 113 may be configured to provide a path inside the isotope production device 100, such as for make-up water, additional cooling fluid outlets, isotope extraction, etc. Make-up water may be used to maintain coolant levels within the isotope production device 100. For example, the coolant within the isotope production device 100 may be a water-based coolant, such as light water, heavy water, or a heavy/light water mix (e.g., 70 mol %/30 mol %, 75 mol %/25 mol%, 80 mol %/20 mol %). In some embodiments, the make-up water may be light-water when introduced in relatively small percentages to the total water in the isotope production device 100.

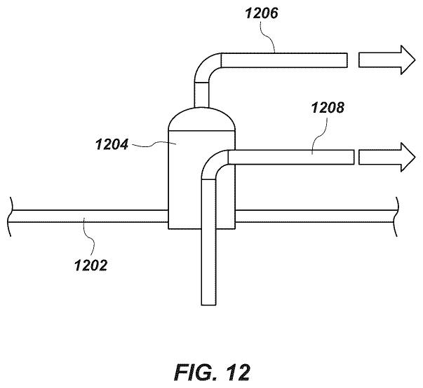

The isotope production device 100 may also be coupled to an extraction device 1204 through one or more apertures 113 in the cap 104, similar to the aperture 112. The apertures 113 may be positioned on a top surface of the cap 104 similar to the aperture 112 or may extend from a side surface of the cap 104. The extraction device 1204 may be configured to provide an external path for an aqueous solution flowing through the isotope production device 100, such that any isotopes present in the aqueous solution may be extracted through a bleed and feed process without stopping the reactions within the isotope production device 100. For example, a bypass line 1202 or extraction line may be coupled to the extraction device 1204 through one or more of the additional apertures 113 in the cap 104. The bypass line 1202 or extraction line may include equipment configured to extract (e.g., harvest) the desired isotopes from the aqueous solution. The equipment may remove one or more of the medical isotopes from the aqueous solution by conventional techniques. The aqueous solution may then be injected back into the isotope production device 100 through another of the apertures 113 in the cap 104. An embodiment of an extraction device 1204 is described in further detail below with respect to FIG. 12.

FIG. 2 illustrates a cross-sectional view of the isotope production device 100. The isotope production device 100 may include a core 206 in a central portion of the isotope production device 100. The core 206 may be the area of the isotope production device 100 where the nuclear reactions occur. The core 206 may be substantially surrounded by shielding 208. The shielding 208 may be formed from a material configured to reflect free neutrons back into the core 206, such that the free neutrons do not escape the core 206 and the chain reactions in the core 206 may be maintained.

The fuel within the core 206 may be in the form of an aqueous fuel solution (e.g., the fuel may be dissolved in the coolant or aqueous solution), such that the fuel may flow through the isotope production device 100 with the coolant or aqueous solution. For example, the fuel may be an aqueous solution of Uranyl-Nitrate (UO₂(NO₃)₂) and a heavy/light water mix, such as 70 mol %/30 mol %, 75 mol %/25 mol %, 80 mol %/20 mol %, or 85 mol %/15 mol %. The aqueous fuel solution may enable the isotope production device 100 to operate at lower temperatures than a conventional molten salt reactor. For example, a conventional molten salt reactor may be operated at temperatures of greater than about 500° C., such as greater than about 800° C. These high temperatures may require advanced materials to withstand the elevated temperatures and associated pressures. The aqueous fuel solution in the isotope production device 100 according to embodiments of the disclosure may flow in a similar manner to the molten salt. However, due to the solution being aqueous, the isotope production device 100 may be operated at temperatures in the range from about 0° C. to about 300° C., such as from about 50° C. to about 100° C. The relatively low operating temperatures may facilitate the use of materials in the isotope production device 100 that are common and relatively less expensive in comparison to specialty materials that may be used to withstand higher operating temperatures in a conventional reactor.

Similar to the lower operating temperatures, the material properties of an aqueous fuel solution may be less damaging to the materials of an associated isotope production device 100, which may facilitate the use of common materials. For example, an aqueous solution of Uranyl-Nitrate may cause less damage to materials contacting the aqueous solution than a molten salt solution. The aqueous solution of uranyl-nitrate may be less corrosive than a molten salt solution. Furthermore, an aqueous solution of uranyl-nitrate may promote corrosion resistance and/or chemical passivation in some materials, such as stainless steel (e.g., stainless steel 304L, stainless steel 316L, stainless steel 316H, INCOLOY 800®, Hastelloy N, Alloy 242, Alloy 800H, Alloy 800HT, Alloy 617, etc.).

The isotope production device 100 may define a fluid path throughout the isotope production device 100 that may be driven by the heat produced by the reactions in the core 206. For example, the flow through the isotope production device 100 may be driven by natural convection. The heat generated by the reactions in the core 206 may cause the fluid (e.g., aqueous fuel solution) in the core 206 to rise within the core 206. For example, if a temperature of the fluid in the core 206 is raised by about 100° C. in the core 206 (e.g., the change in temperature of the fluid from a bottom of the core 206 to a top of the core 206 is about 100° C.), the fluid may flow upward in the core 206 at a velocity in a range from about 3 cm/s to about 5 cm/s, such as about 4 cm/s. In addition to the rise in temperature across the core 206, the velocity of the fluid through the core 206 may depend on additional elements, such as a size and shape of the core 206, additional features in the core 206, such as obstructions, obstacles, flow interrupters, etc., the properties of the fluid (e.g., viscosity, density, surface tension, etc.).

The core 206 may be coupled to a heat exchanger 204 at an upper portion of the core 206. The heat exchanger 204 may be configured to cool the aqueous fuel solution. For example, the heat exchanger 204 may be a liquid to liquid heat exchanger, configured to transfer heat from the aqueous fuel solution to an external cooling fluid, such as water. In some embodiments, the heat exchanger 204 may be a liquid to air heat exchanger, configured to transfer heat from the aqueous fuel solution to ambient air surrounding the isotope production device 100.

The isotope production device 100 may define a return path 202 between the casing 102 and the shielding 208. The return path 202 may allow the cooled aqueous fuel solution to flow back to a bottom portion of the isotope production device 100.

The downward flow of the cooled aqueous fuel solution may be redirected by a cap 214 on a bottom axial end of the isotope production device 100. The cap 214 may include vanes 212 configured to direct the flow of the aqueous fuel solution in a radially inward direction. The cap 214 and associated vanes 212 may direct the flow of the aqueous fuel solution radially inward to a central portion of the isotope production device 100 near a bottom portion of the core 206.

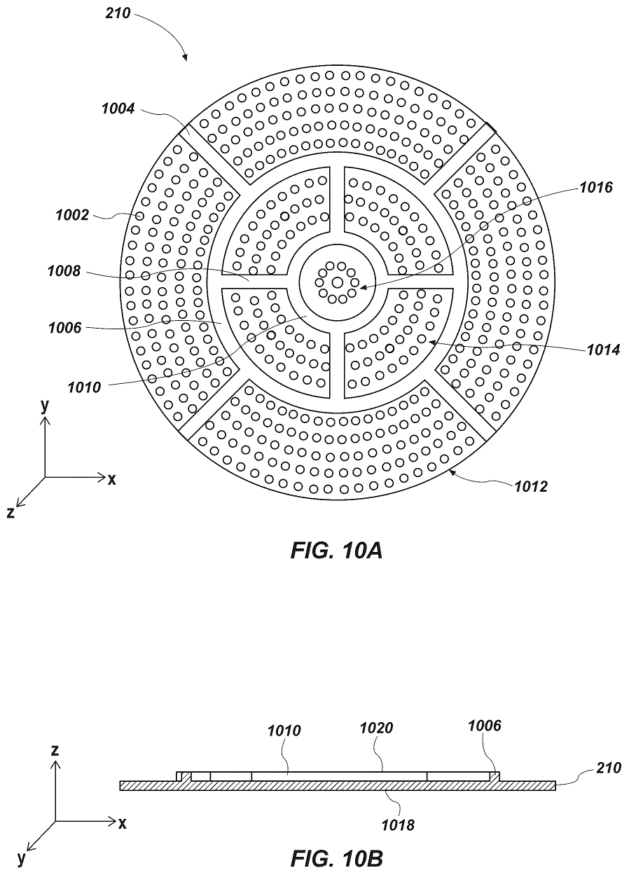

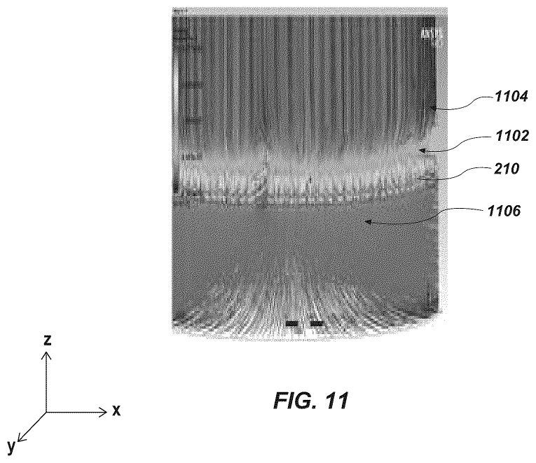

The aqueous fuel solution may flow back into the bottom portion of the core 206 through an orifice plate 210. The orifice plate 210 may be configured to control flow of the aqueous fuel solution in the core 206, such that the flow may remain substantially laminar (e.g., without turbulence or vortices forming), such that the upward flow of the aqueous fuel solution may be substantially uniform through the core 206. The orifice plate 210 and associated effects on the flow of the aqueous fuel solution are described in further detail below with respect to FIGS. 10A-11.

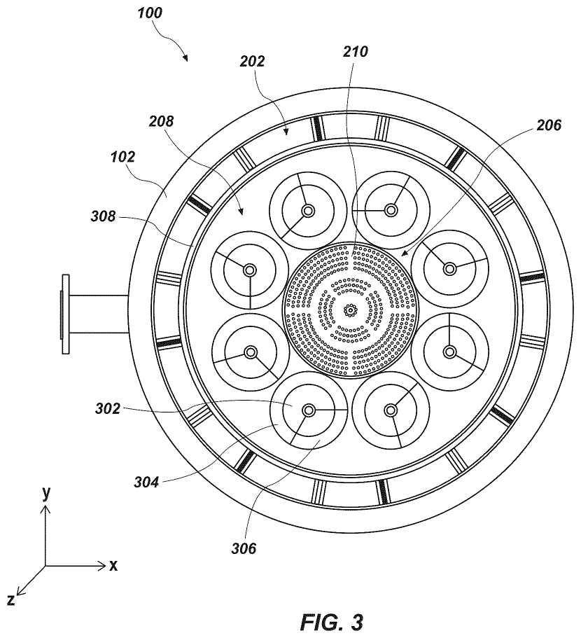

FIG. 3 illustrates a view of the isotope production device 100 with the cap 214 at the axial end of the isotope production device 100 proximate the bottom portion of the core 206 removed to view the internal components of the isotope production device 100. As illustrated, the isotope production device 100 may include an arrangement of nested cylinders. The core 206 may be the innermost cylinder. The core 206 may be nested within the shielding 208. As described above, the shielding 208 may be formed from a neutron reflecting material, configured to maintain the free neutrons within the core 206.

The shielding 208 may include control drums 302 disposed therein. The control drums 302 may be arranged around the core 206. The control drums 302 may include a neutron-absorbing material 306 disposed over a first radial portion of the each control drum 302 and shielding 304 disposed over a second larger radial portion of each control drum 302. The control drums 302 may be used to control the reactions occurring within the core 206 by changing the position of the neutron-absorbing material 306 of each of the control drums 302 relative to the core 206. As the neutron-absorbing material 306 is positioned closer to the core 206, the neutron-absorbing material 306 may absorb a larger amount of the free neutrons from the core 206, reducing the number of reactions occurring within the core 206. As the control drums 302 are rotated to place the neutron-absorbing material 306 a greater distance from the core 206, the number of free neutrons within the core 206 may increase, increasing the number of reactions occurring. Once the reactions within the core 206 stabilize (e.g., equilibrate) to a desired intensity, the control drums 302 may remain in substantially the same position only rotating to account for fuel level changes unless the reactor is shutdown or the production rate of the reactor is changed.

The shielding 208 may be substantially surrounded by an inner casing 308. The inner casing 308 may be formed from one or more layers of additional shielding or reflective materials. The inner casing 308 may be configured to substantially prevent free neutrons and/or radiation from exiting the shielding 208. The return path 202 may be a cylindrical space defined between the inner casing 308 and the casing 102. Thus, the core 206, and shielding 208 may be substantially cylindrical components that are nested within the casing 102, which may also be a substantially cylindrical component. As described above, the aqueous fuel mixture may flow up through the core 206 in the center through natural convection and return around the outer perimeter through the return path 202 defined between the inner casing 308 and the casing 102.

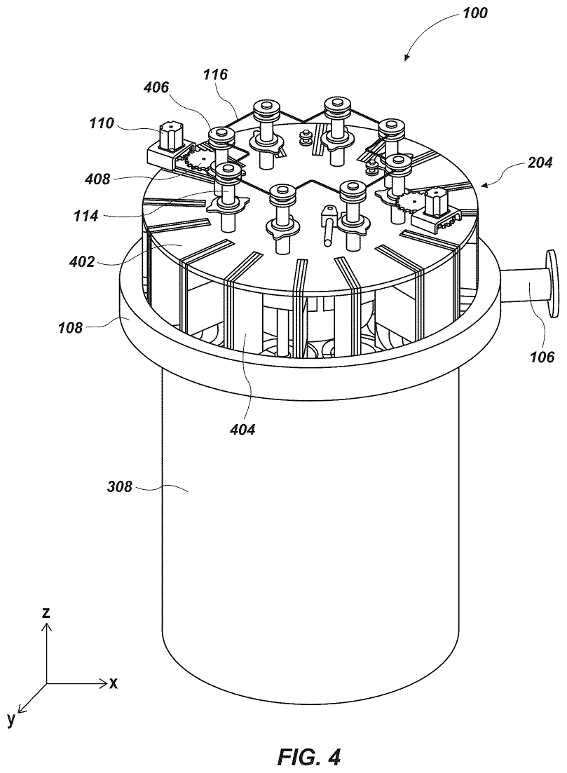

FIG. 4 illustrates the isotope production device 100 with the casing 102 removed to view the internal components of the isotope production device 100. The heat exchanger 204 may be positioned on an axial end of the isotope production device 100 near a top portion of the core 206 (FIG. 2). The heat exchanger 204 may include an array of fins 404 arranged radially about the core 206. The aqueous fuel solution exiting the core 206 may travel between the fins 404 transferring heat from the aqueous fuel solution to the fins 404. The fins 404 may then transfer heat from the fins 404 to a surrounding fluid, such as a liquid (e.g., water, coolant, oil, etc.) or a gas (e.g., ambient air). The fins 404 may be configured to create a larger surface area over which to transfer heat from the aqueous fuel solution to the surrounding fluid, which may increase the amount of heat removed from the aqueous fuel solution by the heat exchanger 204.

The isotope production device 100 may include a top plate 402 configured to redirect the flow of the aqueous fuel solution radially through the heat exchanger 204. The top plate 402 may be constructed from a radioactive shielding or neutron reflective material configured to substantially retain the free neutrons within the core 206. The top plate 402 may also be configured to support and/or position the drive shafts 114 for the control drums 302. The top plate 402 may be coupled to the cap 104 and may operatively couple the heat exchanger 204, the fins 404, and other associated components to the cap 104 of the isotope production device 100.

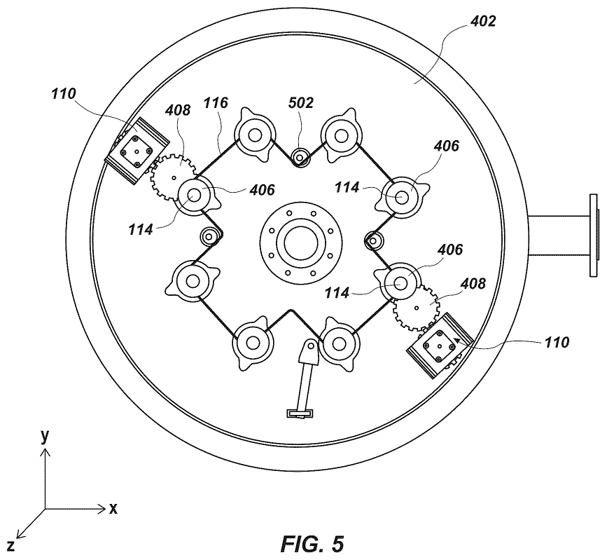

FIG. 5 illustrates a top view of the isotope production device 100. The drive shafts 114 may pass through the top plate 402 at the respective radial positions. Each of the drive shafts 114 may include a pulley 406. The pulley 406 may be configured to interface between the drive shaft 114 and the belt 116. The belt 116 may be configured to rotationally couple each of the drive shafts 114 together, such that the drive shafts 114 each rotate at substantially the same time and speed. Thus, the belt 116 may enable multiple drive shafts 114 to be driven by a single control drive 110.

The top plate 402 may include additional tensioners 502 configured to maintain tension along the belt 116 to reduce slippage between the belt 116 and the pulleys 406. In some embodiments, the tensioners 502 may be substantially stationary, such that the tensioners 502 provide passive tension and are manually repositioned to increase or decrease tension in the belt 116. In other embodiments, the tensioners 502 may provide active tension, such as through a spring configured to move so as to maintain substantially the same amount of tension on the belt 116 as the belt 116 stretches during use. In some embodiments, the top plate 402 may include both passive and active tensioners 502.

The control drives 110 may be configured to interface with at least one drive shaft 114 through a drive gear 408. The drive gear 408 may cause the associated drive shaft 114 to rotate and the rotation of the associated drive shaft 114 may be transferred to the other drive shafts 114 through the belt 116 and pulleys 406.

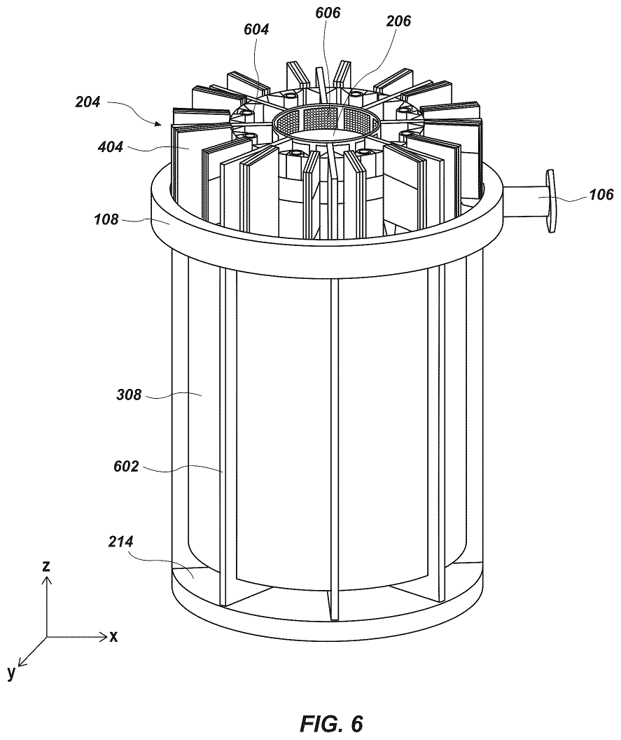

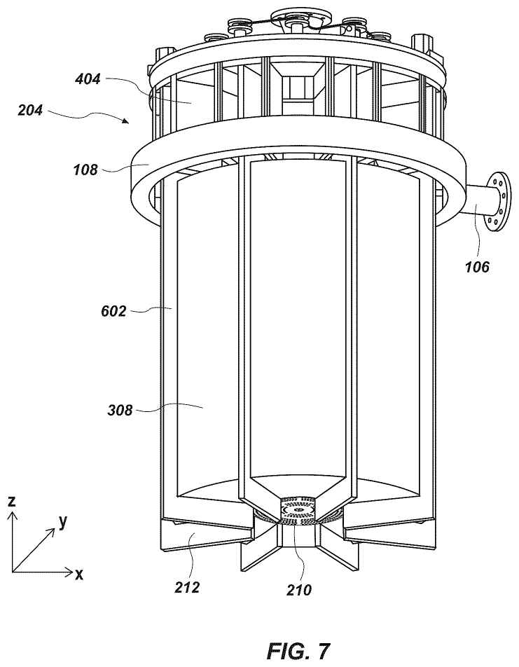

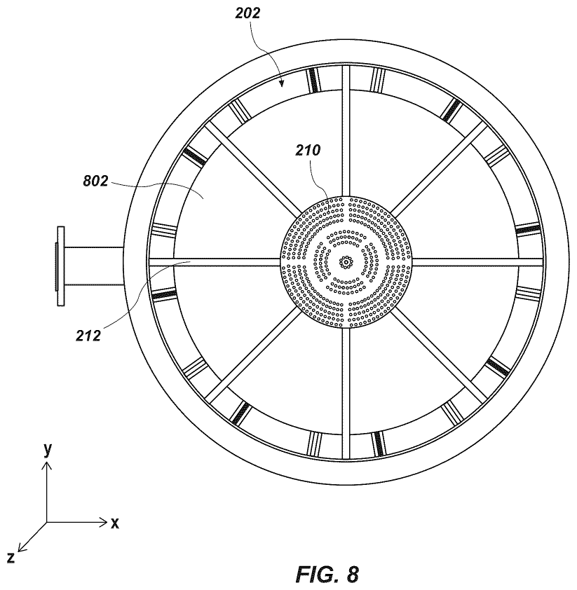

FIG. 6 through FIG. 8 illustrate the isotope production device 100 with the casing 102, caps 104, 214, top plate 402, and control drive mechanisms removed to view the flow path of the isotope production device 100. As described above, the aqueous fuel solution may flow up through the core 206 by convection (e.g., natural convection). A top portion of the core 206 may include one or more core outlets 606. The core outlets 606 may include multiple apertures through a side wall of the core 206. The aqueous fuel solution may pass through the apertures in the side wall of the core 206 and into the heat exchanger 204. The core outlets 606 may substantially coincide with the heat exchanger 204. For example, the core outlets 606 may be at substantially the same axial position along the core 206 as the heat exchanger 204. The core outlets 606 may be configured to direct the flow of the aqueous fuel solution into the heat exchanger 204.

When the aqueous fuel solution reaches a top portion of the isotope production device 100, proximate the cap 104, a portion of the aqueous fuel solution may be removed from the isotope production device 100 through one or more apertures in the cap 104 and diverted through the extraction device, described above. Any desirable isotopes (e.g., the medical isotope(s) of interest) present in the aqueous fuel solution may be extracted from the aqueous fuel solution in an external device. As described above, this may enable the desired isotopes to be removed from the aqueous fuel solution without stopping the reactions in the core 206. Therefore, the isotope production device 100 may continue to operate while the desired isotopes are extracted.

The diverted aqueous fuel solution may be re-introduced into the isotope production device 100 through another aperture in the cap 104. The diverted aqueous fuel solution may then flow to the heat exchanger 204 along with the aqueous fuel solution that was not diverted.

The heat exchanger 204 may include multiple diverters 604 configured to divert the flow of the aqueous fuel solution into the respective banks of fins 404. The diverters 604 may be arranged about the drive shafts 114 of the control drums 302, such that the aqueous fuel solution may be diverted around the drive shafts 114 without contacting the drive shafts 114.

The aqueous fuel solution may then pass along a return path 202 defined between the casing 102 and the inner casing 308. The isotope production device 100 may include one or more vanes 602 positioned between the inner casing 308 and the casing 102. The vanes 602 may be configured to control and direct flow of the aqueous fuel solution through the return path 202, such that the flow may remain in a substantially axial direction from the heat exchanger 204 to the cap 214 near the bottom portion of the core 206.

Near the bottom portion of the isotope production device 100, the flow of the aqueous fuel solution may be redirected by cap 214 to flow between the cap 214 and a base plate 802. The base plate 802 may include vanes 212 as described above, configured to direct the flow of the aqueous fuel solution in a radially inward direction toward the core 206. The base plate 802 may include an aperture into the core 206, which may include the orifice plate 210. As described in further detail below, the orifice plate 210 may include multiple apertures and directional vanes configured to control flow of the aqueous fuel solution into the core 206.

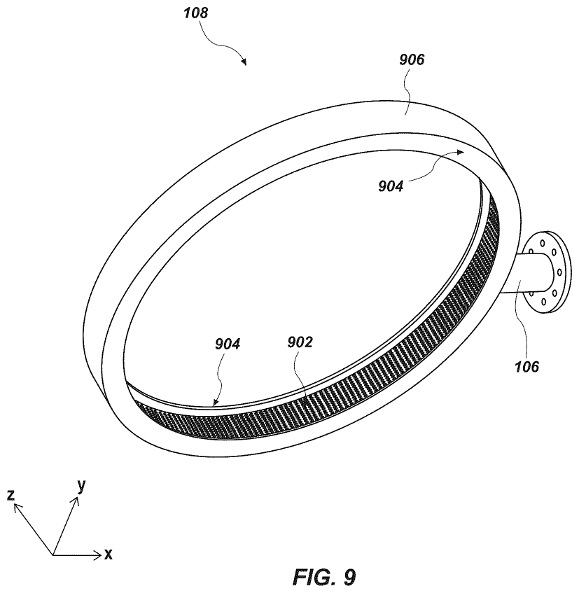

FIG. 9 illustrates a perspective view of the distribution ring 108. The distribution ring 108 may be an annular or ring-like structure, configured to substantially surround the heat exchanger 204. As described above, a cooling fluid may flow into the distribution ring 108 through an inlet 106. The distribution ring 108 may include a perforated wall 902 on an inner portion of the distribution ring 108. The perforated wall 902 may be configured to restrict flow of the cooling fluid into the region surrounding the heat exchanger 204. Restricting the flow of the cooling flow may facilitate a substantially uniform distribution of the cooling fluid about the heat exchanger 204 by causing portions of the cooling fluid to flow away from the inlet 106 before exiting the distribution ring through the perforated wall 902. The distribution ring 108 may also include axial walls 904 defining a top and bottom of the distribution ring 108 and an outer wall 906.

FIGS. 10A and 10B illustrate different views of the orifice plate 210. The orifice plate 210 may include a plurality of apertures 1002 through the orifice plate 210. The apertures 1002 may be substantially uniform (e.g., the apertures 1002 may all have substantially the same size and the same shape). However, the apertures 1002 may be of different sizes and shapes as long as the substantially uniform flow of the aqueous fuel solution through the core 206 is achieved. The orifice plate 210 may restrict flow of the aqueous fuel solution, which may create a change in pressure (e.g., a reduction in pressure) across the orifice plate 210. The change in pressure may be less than about 1 Pascal (Pa), such as less than about 0.9 Pa, or less than about 0.8 Pa. An average velocity of the aqueous fuel solution passing through the orifice plate 210 may be in a range from about 0.2 cm/s to about 1 cm/s, such as between about 0.3 cm/s and about 0.5 cm/s. The apertures 1002 may have a major dimension (e.g., diameter, apothem, width, etc.) in the range from about 1 millimeter (mm) to about 5 mm, such as about 2 mm. In some embodiments, the apertures 1002 may be substantially circular in shape. In other embodiments, the apertures 1002 may have other shapes, such as rectangular shapes, triangular shapes, etc. The apertures 1002 may be arranged in annular rings about the surface of the orifice plate 210 with substantially uniform spacing between each of the apertures 1002. However, the apertures 1002 may be non-uniformly spaced as long as the substantially uniform flow of the aqueous fuel solution through the core 206 is achieved.

The orifice plate 210 may be separated into different segments 1012, 1014, 1016 by ridges 1004 and 1008. The ridges 1004 and 1008 may extend from an outlet side 1020 of the orifice plate 210 to a substantially uniform height. The substantially uniform height may be less than about 5 centimeters (cm), such as between about 0.5 cm and about 3 cm, or about 1 cm. The ridges may form a first set of outer ridges 1004 extending from an outer ring 1006 and a second set of inner ridges 1008 extending between the outer ring 1006 and an inner ring 1010. The first set of outer ridges 1004 and the second set of inner ridges 1008 may not be angularly aligned. For example, the first set of outer ridges 1004 and the second set of inner ridges 1008 may be angularly offset by between about 0° and about 90°, such as between about 30° and about 60°, or about 45°.

The outer ridges 1004 may divide the orifice plate 210 into two or more outer segments 1012, such as four outer segments 1012. The outer segments 1012 may be the portions of the orifice plate 210 between two outer ridges 1004 and between the outer ring 1006 and an outer edge of the orifice plate 210. The inner ridges 1008 may divide the orifice plate 210 into two or more inner segments 1014. The inner segments 1014 may be the portions of the orifice plate 210 between two inner ridges 1008 and between the inner ring 1010 and the outer ring 1006. In some embodiments, the number of outer segments 1012 may be substantially the same as the number of inner segments 1014. The inner ring 1010 may also define a center segment 1016. The density of the apertures 1002 in each segment may be substantially uniform, such that each segment has substantially the same number of apertures 1002 in a given area.

The orifice plate 210 may have an inlet side 1018 and outlet side 1020. The outlet side 1020 may be configured to face the core 206 when installed and the inlet side 1018 may be configured to face the cap 214 on the bottom portion of the isotope production device 100, such that the aqueous fuel solution flows into the orifice plate 210 through the inlet side 1018 and out of the orifice plate 210 and into the core 206 through the outlet side 1020 of the orifice plate 210.

The orifice plate 210 may be constructed from a material configured to resist corrosion and other undesirable chemical reactions with the aqueous fuel solution. For example, the orifice plate 210 may be formed from stainless steel (e.g., stainless steel 304L). Constructing the orifice plate 210 from a corrosion resistant material may extend a life of the orifice plate 210 and may improve long term predictability of the effect of the orifice plate 210 on the flow of the aqueous fuel solution into the core 206.

FIG. 11 illustrates a flow model of the fluid flowing through the orifice plate 210. As described above, the orifice plate 210 may be configured to control the flow of the aqueous fuel solution entering the core 206. The aqueous fuel solution may flow into the orifice plate 210 on the inlet side 1018 as illustrated in the inlet flow region 1106. As the aqueous fuel solution exits the orifice plate 210 on the outlet side 1020, there may be a turbulent flow region 1102 and a laminar flow region 1104. The turbulent flow may reduce the efficiency, predictability, and stability of the nuclear reactions in the turbulent flow region 1102. Therefore, the orifice plate 210 may be configured to minimize the size of the turbulent flow region 1102, such that the flow of the aqueous fuel solution through the core 206 is substantially uniform and constant.

FIG. 12 illustrates an extraction device 1204 coupled to a bypass line 1202, which may be coupled to the cap 104 (FIG. 1) through one or more apertures 112 (FIG. 1) in the cap 104 (FIG. 1). The apertures 112 (FIG. 1) may extend to locations in the isotope production device 100 (FIG. 1) where the aqueous solution is present, such that the aqueous solution may enter the bypass line 1202 through one of the apertures 112 (FIG. 1) and may reenter the isotope production device 100 (FIG. 1) through another of the apertures 112 (FIG. 1).

The aqueous solution may flow into the extraction device 1204 positioned along the bypass line 1202. The extraction device 1204 may be configured to extract isotopes from the aqueous solution through a liquid stream flowing through a liquid transfer line 1208 and through a gas transfer line 1206 configured to collect gaseous isotopes from a chamber in the extraction device 1204. The isotopes may be extracted from the aqueous solution in the extraction device 1204 through conventional methods, such as filters, chemical separation, etc. The aqueous solution may then flow out of the extraction device 1204 and back into the isotope production device 100 (FIG. 1) through the bypass line 1202.

The embodiments of the disclosure may provide a less expensive nuclear reactor (e.g., the isotope production device) for producing isotopes that is capable of stable operation at low temperatures and pressures. Low operating temperatures and pressures may enable the reactor to be built from conventional materials, such as stainless steel, rather than more expensive advanced materials. Furthermore, operating the reactor stably at lower temperatures and pressures may enable the reactor to be used safely in close proximity to or even within a hospital or medical facility with much lower shielding requirements. Reducing the cost of the reactor may enable the reactor to be installed at or near hospitals or other medical facilities without being cost prohibitive. This may enable the isotopes to be more effectively produced and utilized for medical procedures and therapies.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the disclosure, in addition to those shown and described herein, such as alternative useful combinations of the elements described, may become apparent to those skilled in the art from the description. Such modifications and embodiments are also intended to fall within the scope of the appended claims and their legal equivalents.

1. An isotope production device comprising:
a reactor core configured to induce flow of an aqueous fuel solution through natural convection; and
an orifice plate coupled to an inlet of the reactor core, the orifice plate configured to maintain a substantially uniform flow of the aqueous fuel solution through the reactor core, the orifice plate comprising:
a plurality of uniform apertures through the orifice plate; and
one or more ridges extending from a surface of the orifice plate in a direction toward the reactor core.

2. The isotope production device of claim 1, wherein the one or more ridges extend a distance of less than 5 centimeters from the orifice plate.

3. The isotope production device of claim 1, wherein the orifice plate comprises at least two segments defined by the one or more ridges.

4. The isotope production device of claim 1, wherein at least one of the one or more ridges comprises a circular ridge defining an inner segment of the orifice plate and an outer segment of the orifice plate.

5. The isotope production device of claim 1, wherein each aperture of the plurality of uniform apertures through the orifice plate has a major dimension in a range from about 1 mm to about 5 mm.

6. A method of producing isotopes, the method comprising:
heating an aqueous solution in a reactor core through a nuclear reaction;
flowing the aqueous solution through the reactor core;
cooling the aqueous solution in a heat exchanger;
flowing the aqueous solution downward in a return passage after cooling the aqueous solution;
diverting a portion of the aqueous solution after flowing the aqueous solution through the reactor core and before cooling the aqueous solution;
extracting isotopes from the portion of the aqueous solution; and
reintroducing the portion of the aqueous solution into the aqueous solution before cooling the aqueous solution.

7. The method of claim 6, wherein heating the aqueous solution in the reactor core through the nuclear reaction comprises generating a nuclear reaction in an aqueous fuel solution comprising uranyl-nitrate and a heavy/light water mix.

8. The method of claim 6, wherein flowing the aqueous solution through the reactor core comprises flowing the aqueous solution through natural convection.

9. The method of claim 6, wherein heating the aqueous solution comprises heating the aqueous solution to a temperature in a range from about 0° C. to about 300° C.

10. The method of claim 6, further comprising reintroducing the aqueous solution into the reactor core through an orifice plate after flowing the aqueous solution downward in a return passage, wherein the orifice plate is configured to control a flow profile of the aqueous solution entering the reactor core.

11. The method of claim 10, wherein reintroducing the aqueous solution into the reactor core through the orifice plate comprises flowing the aqueous solution across one or more ridges extending from a surface of the orifice plate in a direction toward the reactor core.

12. The method of claim 10, wherein reintroducing the aqueous solution into the reactor core through the orifice plate comprises flowing the aqueous solution through a plurality of uniform apertures in the orifice plate.

13. The method of claim 6, wherein extracting the isotopes from the portion of the aqueous solution comprises one or more of a filtering operation or a chemical separation process.

14. The method of claim 6, wherein extracting the isotopes from the portion of the aqueous solution comprises extracting the isotopes through a bleed and feed process.

15. The method of claim 6, wherein extracting the isotopes from the portion of the aqueous solution comprises extracting the isotopes without stopping the nuclear reaction.

16. An isotope production system comprising:
a reactor core configured to induce flow of an aqueous fuel solution through a nuclear reaction generating natural convection;
a heat exchanger positioned over the reactor core;
a return passage extending between the heat exchanger and a bottom of the reactor core;
an extraction device positioned between the reactor core and the heat exchanger, the extraction device configured to divert a portion of the aqueous fuel solution after flowing the aqueous solution through the reactor core and before cooling the aqueous solution in the heat exchanger; and
an orifice plate coupled between the return passage and the reactor core, the orifice plate configured to maintain a substantially uniform flow of the aqueous fuel solution through the reactor core, the orifice plate comprising:
a plurality of uniform apertures through the orifice plate; and
one or more ridges extending from a surface of the orifice plate in a direction toward the reactor core.

17. The system of claim 16, wherein the aqueous fuel solution comprises a uranyl-nitrate and a heavy/light water mix.

18. The system of claim 16, wherein the extraction device comprises one or more of a filtering device or a chemical separation device.

19. The isotope production device of claim 1, wherein the plurality of uniform apertures are arranged in annular rows about a center of the orifice plate.

20. The isotope production device of claim 1, wherein the plurality of uniform apertures through the orifice plate are arranged with uniform spacing.
